(19) United States
(12) Patent Application Publication
(10) Pub. No.: US 2024/0112022 A1
(43) Pub. Date: Apr. 4, 2024

(54) MALLEABLE CONFIDENCE MODELS AND MACHINE LEARNING PREDICTION

(71) Applicant: The Aerospace Corporation, El Segundo, CA (US)

(72) Inventor: Benjamen Paul Bycroft, Los Angeles, CA (US)

(21) Appl. No.: 17/960,019

(22) Filed: Oct. 4, 2022

(51) Int. Cl. G06N 3/08; G06K 9/62

(52) U.S. Cl. CPC G06N 3/08; G06K 9/6256

(57) ABSTRACT

Systems and methods are provided for adjusting confidence models that are used to generate augmented prediction output or to otherwise determine a degree of confidence in a prediction output. A machine learning model may be trained to generate prediction output (e.g., classification output or regression output), and a confidence model of training data support for predictions of the machine learning model may be generated. The data modeled by the confidence model may initially be the feature space representation of the training data. The confidence model may be a malleable confidence model in the sense that when the machine learning model is used by an inference service to evaluate operational data, the prediction output and/or operational data input may be used to adjust the confidence model based on observed changes and data.

### BACKGROUND

Models representing data relationships and patterns, such as functions, algorithms, systems, and the like, may accept input (sometimes referred to as an input vector), and produce output (sometimes referred to as an output vector) that corresponds to the input in some way. For example, a machine learning model may be implemented as an artificial neural network. Artificial neural networks are artificial in the sense that they are computational entities, analogous to biological neural networks, but implemented by computing devices. Output of neural network-based models is typically in the form of a score. The parameters of a neural network-based models can be set in a process referred to as training.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a diagram of illustrative data flows and interactions between a model training service, an inference service, and a management system according to some embodiments.

FIG. 2 is a diagram of training an illustrative artificial neural network and generating a confidence model for training-support-based augmentation according to some embodiments.

FIG. 3 is a diagram of using an illustrative artificial neural network at inference time and adapting a confidence model according to some embodiments.

FIG. 4 is a flow diagram of an illustrative process for adapting a malleable confidence model based on operational data and predictions generated during inference according to some embodiments.

FIG. 5 is a diagram of illustrative distributions in a feature space and adapting confidence model evaluation of the feature space according to some embodiments.

FIG. 6 is a diagram of an illustrative confidence model with adapters according to some embodiments.

FIG. 7 is a flow diagram of an illustrative process for adapting a malleable confidence model based on operational data and predictions generated during inference according to some embodiments.

FIG. 8 is a diagram of illustrative distributions in a feature space and adapting confidence model evaluation of the feature space according to some embodiments.

FIG. 9 is a block diagram of an illustrative computing system configured to implement aspects of the present disclosure according to some embodiments.

### DETAILED DESCRIPTION

The present disclosure is directed to adjusting confidence models that are used to generate augmented prediction output or to otherwise determine a degree of confidence in prediction output. Generally described, a machine learning model may be trained to generate prediction output (e.g., classification output or regression output), and a confidence model of training data support for predictions of the machine learning model may be generated. The data modeled by the confidence model may initially be the feature space representation of the training data, resulting classification or regression determinations made by the machine learning model during training, labels associated with the training data, other information, or some combination thereof. The confidence model may be a malleable confidence model in the sense that when the machine learning model is used by an inference service to evaluate operational data, the operational input data and/or predication output data may be used to adjust the confidence model based on observed changes and the like.

Some conventional machine learning models are configured and trained to produce classification scores that reflect the likelihood or “confidence” that a particular input is properly classified or not classified in a particular classification. For example, input may be analyzed using a machine learning model, and the output of the analysis for a particular classification may be a classification score in the range [0.0, 1.0]. A higher score indicates a higher probability or confidence that the input is properly classified in the particular classification, and a lower score indicates a lower probability or confidence that the input is properly classified in the particular classification. However, although the output may be generated by a trained and tested model, the model may not have been trained and tested using data that is similar to the particular operational data currently being analyzed by the model. In some cases, a model may have been trained using an adequate or significant amount of training data that is similar to the particular data currently being analyzed by the model, but the trained model may generate output that is associated with a high number of false positives and/or false negatives for such data. When relevant training data is lacking or the results produced by the trained model on relevant training data are not adequately reliable, the trained model nevertheless still produces classification output. The output may be indicative of a relatively high confidence in a classification determination (e.g., the confidence score may be close to 1.0) and may be provided without any indication that the training basis is inadequate, or that the model is unreliable in that region of the feature space. Thus, a consumer of such model output may not have any way of discriminating between high confidence scores in cases where there is a substantial training basis and an effective model, and high confidence scores in cases where there is a lack of adequate training basis or an ineffective model. Similar issues arise with conventional machine learning models configured and trained to produce regression output. Although the regression models may be associated with confidence metrics that are determined over the entire domain of inputs, a consumer of output from such a model may not have any way of determining the confidence with which any particular output was generated from any particular input.

To address training-support-based issues, a training-support-based confidence model may be generated in a machine learning model's feature space. The training-support-based confidence model may be used to augment machine learning model output in cases where the machine learning model is impacted by false positives/false negatives, and produces outputs with erroneously high confidence for points outside the machine learning model's training data. For example, a training-supported-based confidence model may be used to determine a degree of confidence in machine learning model output, where the confidence is based on observation and training on inputs with similar features. The degree of confidence may be used to weight or otherwise adjust machine learning model output (e.g., classification or regression output), or may be provided as additional data with machine learning model output. However, using such training-support-based confidence models of the machine learning model's feature space may in some cases result in feature space points outside the training data being given low confidence due to lack of training data with similar features, even if the machine learning model output is accurate. Similar effects can occur in regions of false positives and false negatives. Such effects may be observed immediately after training (e.g., due to the limited available training data) or may develop over time (e.g., as operational input diverges from or is otherwise different from the training data). Moreover, certain inadequacies in training data (e.g., biases) may in some cases be discovered only after training and deployment of the machine learning model and corresponding confidence model.

Some aspects of the present disclosure address some or all of the issues noted above, among others, through adjustment of confidence models (including training-support-based confidence models) based on operational data observed at inference time. In some embodiments, confidence models and components (e.g., generative confidence models and/or kernels) originally established in a method such as the one referenced above may then be continuously adapted or otherwise adjusted by modifying parameters of the confidence models and/or components. The adaptation may be based on the external influence of new and/or novel inputs, knowledge of the associated machine learning model's performance, or the like. Advantageously, this approach can build on the benefits of training-support-based confidence models by providing continuous adaptation beyond the initial machine learning model training to accommodate new information about classification or regression confidence without requiring retraining of an associated machine learning model, as is done in traditional continuous learning practices. Rather than retrain the machine learning model itself, a confidence model of the machine learning model's feature space and/or training set may be reshaped to accommodate or re-weight confidence for inputs which land outside the training set feature space, add confidence to a region of the feature space, or decrease confidence in a region of the feature space.

In an illustrative embodiment, training-support-based confidence models may be generative models such as mixture density functions (e.g., Gaussian mixture models, Gaussian process models, kernel density models, etc.) describing the feature space of a machine learning model such as a neural network. Collectively such statistical constructs may be referred to as distributions. In some cases, kernels may also or alternatively be established for refinement of classification/regression in inseparable regions of the feature space. Adaptation of parameters of the mixture density functions/kernels based on operational data and inference can provide continuous tuning of the mixture density functions/kernels beyond the initial or offline data used to train the neural network. For example, in a classifier network, a feature space representation of a new operational input may fall just outside a well-classified region from the training set. A mixture density function governing the confidence for that nearest region may indicate low confidence for such a feature space point because it lies in an area of low confidence based on training data support, or the feature space point may not be classified with confidence at all if it is outside the nearest modeled region from training data. The mixture density function for the region's confidence could be adjusted to increase confidence in the new feature space point and, optionally, for points in the region of the new feature space point. A method such as a Kalman filter could be employed to perform estimation and adjustment of the existing mixture function parameters, continuously adjusting the weight of the established model relative to new inputs. In some embodiments, the underlying machine learning model may also be malleable such that it could be modified to allow this observed feature space point to be accepted into a nearest class, if it falls outside the region in which it would be classified into the class.

Additional aspects of the present disclosure relate to mitigation of undesirable biases or other anomalies from training through adjustment of feature space models. Some conventional approaches to removing or mitigating undesirable biases or anomalies present in training data involve curating and/or modifying training data and re-training the machine learning model. In contrast, systems and methods described herein can mitigate such biases or anomalies in training data through adjustment of the models in the feature space. Advantageously, adjustment of the models in the feature space can be done without costly retraining of the models (e.g., costly from a financial, timing, and/or effort standpoint) or without otherwise taking the system or model offline.

In an illustrative embodiment, a neural network may be trained to evaluate prospective employee applications for a job using training data regarding historical candidate selections. The training may be flawed due to biases by previous hiring management which removed certain applicants (e.g., those living in particular neighborhoods) from consideration. A conventional approach to addressing this issue would necessitate curation of—and additional processing of—the training data and re-training of the network, which could successfully resolve the identified issue. However, that process may be resource intensive (e.g., training of some models may take hours or days even on high performance computing systems), and the process may itself have unintended consequences on network performance due to the alterations to the training set. In contrast, by adjusting the network through a re-weighting of the model in the feature space, the identified network biases may be mitigated. In some embodiments, kernels could also or alternatively be created or adjusted to resolve the issue without retraining the neural network or without otherwise taking the neural network offline.

Various aspects of the disclosure will now be described with regard to certain examples and embodiments, which are intended to illustrate but not limit the disclosure. Although the examples and embodiments described herein will focus, for the purpose of illustration, on specific calculations and algorithms, one of skill in the art will appreciate the examples are illustrative only, and are not intended to be limiting. In addition, any feature, process, device, or component of any embodiment described and/or illustrated in this specification can be used by itself, or with or instead of any other feature, process, device, or component of any other embodiment described and/or illustrated in this specification.

### Example Computing Environment

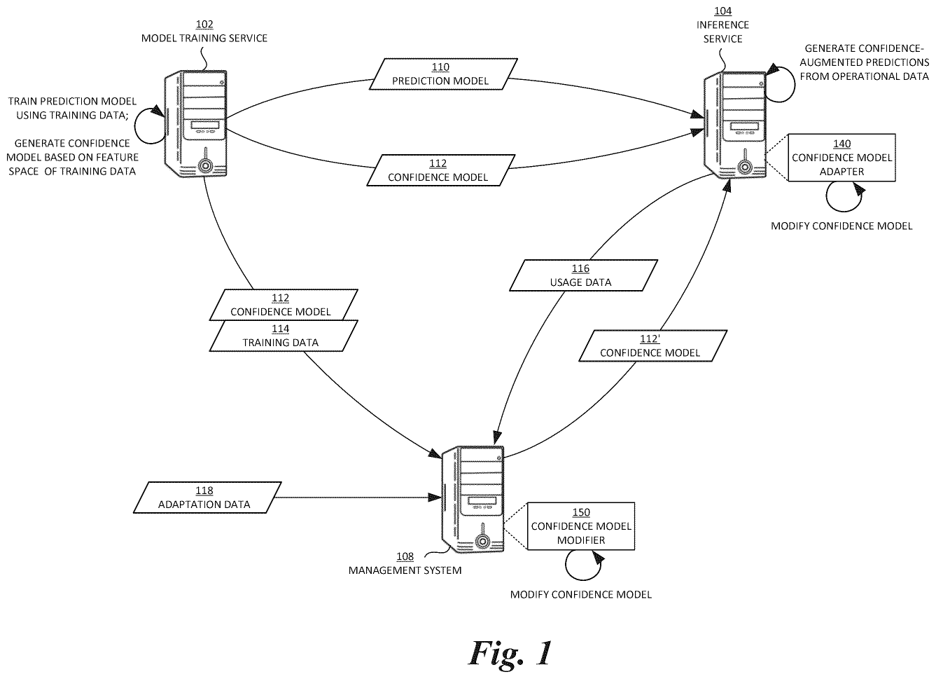

FIG. 1 shows an example computing environment in which aspects of the present disclosure may be implemented. In some embodiments, as shown, the computing environment may include a model training service 102, an inference service 104, and a management system 108.

The model training service 102, inference service 104, and management system 108 may communicate with each other via one or more communication networks (omitted from the illustration for simplicity). In some embodiments, a communication network (also referred to simply as a “network”) may be a publicly-accessible network of linked networks, possibly operated by various distinct parties, such as the Internet. In some cases, the network may be or include a private network, personal area network, local area network, wide area network, global area network, cable network, satellite network, cellular data network, etc., or a combination thereof, some or all of which may or may not have access to and/or from the Internet.

The model training service 102 may be a logical association of one or more computing systems for training machine learning models and corresponding confidence models. The model training service 102 (or individual components thereof) may be implemented on one or more physical computing systems such as blade servers, midrange computing devices, mainframe computers, desktop computers, or any other computing device configured to provide computing services and resources. The model training service 102 may include any number of such computing systems.

The inference service 104 may be a logical association of one or more computing systems for using machine learning models and corresponding confidence models to evolution operational data and generate confidence-augmented prediction output. For example, the inference service 104 may include a confidence model adapter 140 to adapt a confidence model based on operational input and prediction output generated by a corresponding machine learning model. The inference service 104 (or individual components thereof) may be implemented on one or more physical computing systems such as blade servers, midrange computing devices, mainframe computers, desktop computers, or any other computing device configured to provide computing services and resources. The inference service 104 may include any number of such computing systems.

The management system 108 may be a logical association of one or more computing systems for using modifying confidence models after the corresponding machine learning models have been trained and the confidence models have been generated (e.g., by the model training service 102). For example, the management system 108 may include a confidence model modifier 150 to modify a confidence model based on biases observed in training data, based on operational input and prediction output generated by inference service 104 using the corresponding machine learning model, etc. The management system 108 (or individual components thereof) may be implemented on one or more physical computing systems such as blade servers, midrange computing devices, mainframe computers, desktop computers, or any other computing device configured to provide computing services and resources. The management system 108 may include any number of such computing systems.

In some embodiments, the features and services provided by the model training service 102, inference service 104, and/or management system 108 may be implemented as web services consumable via one or more communication networks. In further embodiments, the model training service 102, inference service 104, and/or management system 108 (or individual components thereof) are provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

FIG. 1 further illustrates various operations and data flows between the model training service 102, inference service 104, and management system 108. In some embodiments, the model training service 102 may use a set of training data to train a machine learning model to generate prediction output (e.g., classification or regression output). The trained machine learning model may also be referred to as a prediction model 110. The model training service 102 may also generate a model of the feature space of the training data set observed during training of the prediction model. This model may be referred to as a malleable feature space model, a malleable confidence model, or simply as a confidence model 112. The confidence model may be used to provide training-support-based confidence augmentation to output of the prediction model. The prediction model 110 and confidence model 112 may be provided to the inference service 104 and/or the management system 108.

The inference service 104 may use the prediction model 110 and confidence model 112 to generate confidence-augmented predictions from operational data. As used herein the term “operational data” is used to distinguish input data evaluated using the deployed prediction model 110 from other data, such as training data used to train the prediction model 110, any testing data used to test the prediction model 110 before deployment, etc. As used herein, the term “prediction” is used to distinguish operations performed to evaluate operational data using the trained prediction model 110 from operations performed during training to evaluate training data, testing data, etc.

At various points in time or in response to various events, the inference service 104 may modify the confidence model 112 based on use during inference, such as based on operational data evaluated, prediction output generated, etc. For example, the confidence model adapter 140 may modify the confidence model 112 in response to each x prediction outputs generated (where x is some positive integer), each x units of time, or the like. In this way, the confidence model 112 may be a malleable confidence model that represents not just training data support for predictions of the prediction model 110, but is able to adapt to differences or changes in data observed during inference. Example routines for adaptation of confidence models are described in greater detail below.

In some embodiments, the inference service 104 may also or alternatively generate and send usage data 116 to the management system 108. The usage data 116 may include data regarding operational data evaluated using the prediction model 110 and confidence model 112, outputs of the prediction model 110 and/or confidence model 112, other data regarding the operation of the inference service 104 and models, or some combination thereof.

The management system 108 may modify the confidence model 112 based on usage data 116 received from the inference service 104. For example, the confidence model modifier 150 may modify the confidence model 112 based on use during inference, in a manner similar or identical to the confidence model adapter 140. A modified confidence model 112′ may then be sent to the inference service 104 for subsequent use in place of the prior confidence model 112. Example routines for adaptation or otherwise for modification of confidence models are described in greater detail below.

In some embodiments, the confidence model modifier 150 may modify the confidence model 112 based on an evaluation of training data 114 used to generate the confidence model 112. For example, the confidence model modifier 150 may identify biases or anomalies in the training data 114, and may modify the confidence model 112 to mitigate or remove the biases or anomalies. A modified confidence model 112′ may then be sent to the inference service 104 for subsequent use in place of the prior confidence model 112. Example routines for adaptation of confidence models are described in greater detail below.

In some embodiments, the confidence model modifier 150 may modify the confidence model 112 based on other adaptation data 118, such as data not seen during training and not observed during inference. A modified confidence model 112′ may then be sent to the inference service 104 for subsequent use in place of the prior confidence model 112. Example routines for modification of confidence models are described in greater detail below.

### Example Generation and Adjustment of Confidence Model

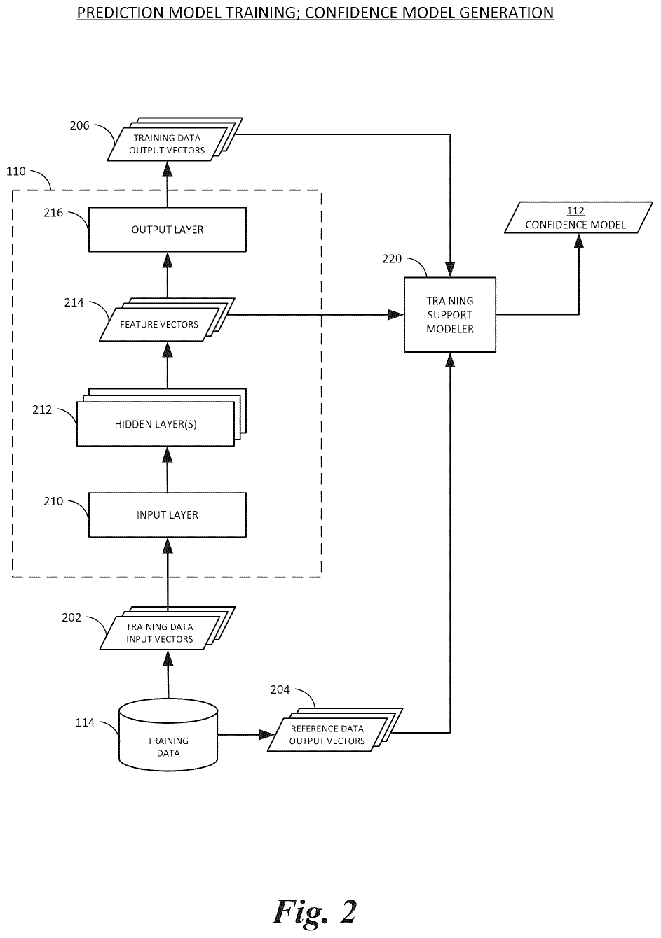

FIG. 2 illustrates training of a prediction model 110 and generation of a confidence model 112 by a model training service 102 according to some embodiments. In the illustrated example, the prediction model 110 is implemented as an artificial neural network (“NN”). However, training-support-based confidence augmentation may be applied to any machine learning model, including but not limited to: neural-network-based classification models, neural-network-based regression models, linear regression models, logistic regression models, decision trees, random forests, support vector machines (“SVMs”), Naïve or non-Naïve Bayes networks, k-nearest neighbors (“KNN”) models, k-means models, clustering models, or any combination thereof. For brevity, aspects of training-supported-based augmentation may not be described with respect to each possible machine learning model that may be used. In practice, however, many or all of the aspects of the disclosure may apply to other machine learning models, including but not limited to those listed herein. In addition, although certain embodiments are described with respect to using certain methods of estimating distributions and mixture densities of training data and/or features derived therefrom, other methods may be used.

Generally described, NNs—including deep neural networks (“DNNs”), convolutional neural networks (“CNNs”), recurrent neural networks (“RNNs”), other NNs, and combinations thereof—have multiple layers of nodes, also referred to as “neurons.” Illustratively, a NN may include an input layer, an output layer, and any number of intermediate, internal, or “hidden” layers between the input and output layers. The individual layers may include any number of separate nodes. Nodes of adjacent layers may be logically connected to each other, and each logical connection between the various nodes of adjacent layers may be associated with a respective weight. Conceptually, a node may be thought of as a computational unit that computes an output value as a function of a plurality of different input values. Nodes may be considered to be “connected” when the input values to the function associated with a current node include the output of functions associated with nodes in a previous layer, multiplied by weights associated with the individual “connections” between the current node and the nodes in the previous layer. When a NN is used to process input data in the form of an input vector or a matrix of input vectors (e.g., a batch of training data input vectors), the NN may perform a “forward pass” to generate an output vector or a matrix of output vectors, respectively. The input vectors may each include n separate data elements or “dimensions,” corresponding to the n nodes of the NN input layer (where n is some positive integer). Each data element may be a value, such as a floating-point number or integer. A forward pass typically includes multiplying the matrix of input vectors by a matrix representing the weights associated with connections between the nodes of the input layer and nodes of the next layer, and applying an activation function to the results. The process is then repeated for each subsequent NN layer. Some NNs have hundreds of thousands or millions of nodes, and millions of weights for connections between the nodes of all of the adjacent layers.

As shown in FIG. 2, the example prediction model 110 implemented as a NN has an input layer 210 with a plurality of nodes, one or more internal layers 212 with a plurality of nodes, and an output layer 216 with a plurality of nodes. The specific number of layers shown in FIG. 2 is illustrative only, and is not intended to be limiting. In some NNs, different numbers of internal layers and/or different numbers of nodes in the input, internal, and/or output layers may be used. For example, in some NNs the layers may have hundreds or thousands of nodes or more. As another example, in some NNs there may be 1, 2, 4, 5, 10, 50, or more internal layers. In some implementations, each layer may have the same number or different numbers of nodes. For example, the input layer 210 or the output layer 216 can each include more or less nodes than the internal layers 212. The input layer 210 and the output layer 216 can include the same number or different number of nodes as each other. The internal layers 212 can include the same number or different numbers of nodes as each other.

Input to a NN, such as the prediction model 110 shown in FIG. 2, occurs at the input layer 210. A single input may take the form of an n-dimensional input vector with n data elements, where n is the number of nodes in the input layer 210. During training, the input vector may be a training data input vector 202. In some cases, multiple input vectors may be input into—and processed by—the NN at the same time. For example, when the NN is trained, a set of training data input vectors 202 (e.g., a “mini batch”) may be arranged as an input matrix. In this example, each row of the input matrix may correspond to an individual training data input vector 202, and each column of the input matrix may correspond to an individual node of the input layer 210. The data element in any given training data input vector 202 for any given node of the input layer 210 may be located at the corresponding intersection location in the input matrix.

The connections between individual nodes of adjacent layers are each associated with a trainable parameter, such as a weight and/or bias term, that is applied to the value passed from the prior layer node to the activation function of the subsequent layer node. For example, the weights associated with the connections from the input layer 210 to the internal layer 212 it is connected to may be arranged in a weight matrix W with a size m×n, where m denotes the number of nodes in an internal layer 212 and n denotes the dimensionality of the input layer 210. The individual rows in the weight matrix W may correspond to the individual nodes in the input layer 210, and the individual columns in the weight matrix W may correspond to the individual nodes in the internal layer 212. The weight w associated with a connection from any node in the input layer 210 to any node in the internal layer 212 may be located at the corresponding intersection location in the weight matrix W.

Illustratively, the training data input vector 202 may be provided to a computer processor that stores or otherwise has access to the weight matrix W. The processor then multiplies the training data input vector 202 by the weight matrix W to produce an intermediary vector. The processor may adjust individual values in the intermediary vector using an offset or bias that is associated with the internal layer 212 (e.g., by adding or subtracting a value separate from the weight that is applied). In addition, the processor may apply an activation function to the individual values in the intermediary vector (e.g., by using the individual values as input to a sigmoid function or a rectified linear unit (“ReLU”) function).

In some embodiments, there may be multiple internal layers 212, and each internal layer may or may not have the same number of nodes as each other internal layer 212. The weights associated with the connections from one internal layer 212 (also referred to as the “preceding internal layer”) to the next internal layer 212 (also referred to as the “subsequent internal layer”) may be arranged in a weight matrix similar to the weight matrix W, with a number of rows equal to the number of nodes in the subsequent internal layer 212 and a number of columns equal to the number of nodes in the preceding internal layer 212. The weight matrix may be used to produce another intermediary vector using the process described above with respect to the input layer 210 and first internal layer 212. The process of multiplying intermediary vectors by weight matrices and applying activation functions to the individual values in the resulting intermediary vectors may be performed for each internal layer 212 subsequent to the initial internal layer.

The intermediary vector that is generated from the last internal layer 212 prior to the output layer 216 may be referred to as a feature vector 214. The feature vector 214 includes data representing the features that have been extracted from the training data input vector 202 by the NN. Illustratively, the feature vector 214 may be thought of as defining a point in the feature space within which the NN is configured to operate. The feature space is determined over the course of design and training of the model, and is expected to encompass the relevant features used to make accurate output determinations (e.g., classification determinations or regression determinations). Thus, the feature vector 214 generated from any given input vector 202 may be considered to be a processed, distilled representation of the relevant information regarding the input vector 202 from which an output determination is to be made.

In some embodiments, an intermediary vector generated from an internal layer other than the last internal layer may be the feature vector 214. For example, the feature vector 214 may include output of the second-to-last internal layer, third-to-last internal layer, first internal layer, or a combination of data from multiple internal layers that may or may not include the last internal layer. Illustratively, such configurations may be beneficial for NN architectures such as autoencoder/decoder networks, U-Nets, RNNs, and the like where feature spaces that would be most useful may found in layers or combinations of layers other than the last internal layer. In some embodiments, there may be no output layer 216, and therefore the feature vector 214 may be final output of the NN.

The output layer 216 of the NN makes output determinations from the feature vector 214. Weights associated with the connections from the last internal layer 212 to the output layer 216 may be arranged in a weight matrix similar to the weight matrix W, with a number of rows equal to the number of nodes in the output layer 216 and a number of columns equal to the number of nodes in the last internal layer 212. The weight matrix may be used to produce an output vector 206 using the process described above with respect to the input layer 210 and first internal layer 212.

The output vector 206 may include data representing the classification or regression determinations made by the NN for the training data input vector 202. Some NNs are configured make u classification determinations corresponding to u different classes (where u is a number corresponding to the number of nodes in the output layer 216, and may be less than, equal to, or greater than the number of nodes n in the input layer 210). The data in each of the u different dimensions of the output vector 206 may be a confidence score indicating the probability that the training data input vector 202 is properly classified in a corresponding class. Some NNs are configured to generate values based on regression determinations. The output value(s) is/are based on a mapping function modeled by the NN. Thus, an output value from a NN-based regression model is the value that corresponds to the training data input vector 202.

The training data 114 from which the training data input vectors 202 are drawn may also include reference data output vectors 204. Each reference data output vector 204 may correspond to a training data input vector 202, and may include the “correct” or otherwise desired output that a model should produce for the corresponding training data input vector 202. For example, a reference data output vector 204 may include scores indicating the proper classification(s) for the corresponding training data input vector 202 (e.g., scores of 1.0 for the proper classification(s), and scores of 0.0 for improper classification(s)). As another example, a reference data output vector 204 may include scores indicating the proper regression output(s) for the corresponding training data input vector. The goal of training may be to minimize the difference between the output vectors 206 and corresponding reference data output vectors 204.

The feature vectors 214, in addition to being used to generate output vectors 206, may also be analyzed to determine various training-support-based metrics. Once the machine learning model has been trained, the training data input vectors 202 may be analyzed again using the trained prediction model 110 to generate feature vectors 214 and output vectors 206. In some embodiments, as shown, a training support modeler 220 may then analyze the output vectors 206 with respect to the corresponding reference data output vectors 204 to determine whether prediction model 110 has produced output in various training-support-based classes. In some embodiments, if the prediction model 110 is a classification model, the training-support-based classes may include: a true positive classification (“TP”), a false positive classification (“FP”), a true negative classification (“TN”), and/or a false negative classification (“FN”) for a given training data input vector 202. The feature vectors 214 generated from each training data input vector 202 may then be tagged or otherwise associated with the TP, FP, TN, and FN determinations. The training support modeler 220 may determine one or more training support mixture density functions, distributions, or related metrics for use in augmenting the classification determinations made by the trained machine learning model and/or for use by the machine learning model itself to generate the classification determinations. In some embodiments, if the prediction model 110 is a regression model, the training-support-based classes may include: a small error, a large positive error, and/or a large negative error for a given training data input vector 202. The feature vectors 214 generated from each training data input vector 202 may then be tagged or otherwise associated with the small error, large positive error, and large negative error determinations. The training support modeler 220 may determine one or more training support mixture density functions, distributions, or related metrics for use in augmenting the regression determinations made by the trained machine learning model and/or for use by the machine learning model itself to generate the regression determinations.

In some embodiments, the training support modeler 220 may determine mixture density functions, distributions, or related metrics of other types. For example, the distributions may also or alternatively include a distribution of all training points regardless of status of TP, FP, TN, FN, large error, small error, etc. (e.g., to identify regions where there is insufficient support for regression determinations). As another example, the distributions may be distributions of any other data available at training time, such as metadata regarding individual training items (e.g., image metadata such as exposure, zoom, lens, date/time, etc.). As a further example, the distributions may be distributions of data derived after training. Illustratively, a NN may be used to detect and identify corners (“keypoints”) of an object in an image. Those keypoints may be used by an unrelated algorithm after the NN to estimate the position and orientation (“pose”) of the object. A distribution for the keypoint detection NN could be generated using the outputs of the pose estimation—such as “error in the true and estimated angle about X, Y, Z”—even if those results were not available at training time for the NN.

Illustrative processes for generating training support mixture density functions, distributions, or related metrics for models, including classification models and regression models, are described in greater detail in commonly-owned U.S. patent application Ser. No. 17/249,604, filed Mar. 5, 2021 and titled Training-Support-Based Machine Learning Classification and Regression Augmentation, the contents of which are incorporated by reference herein and made part of this specification.

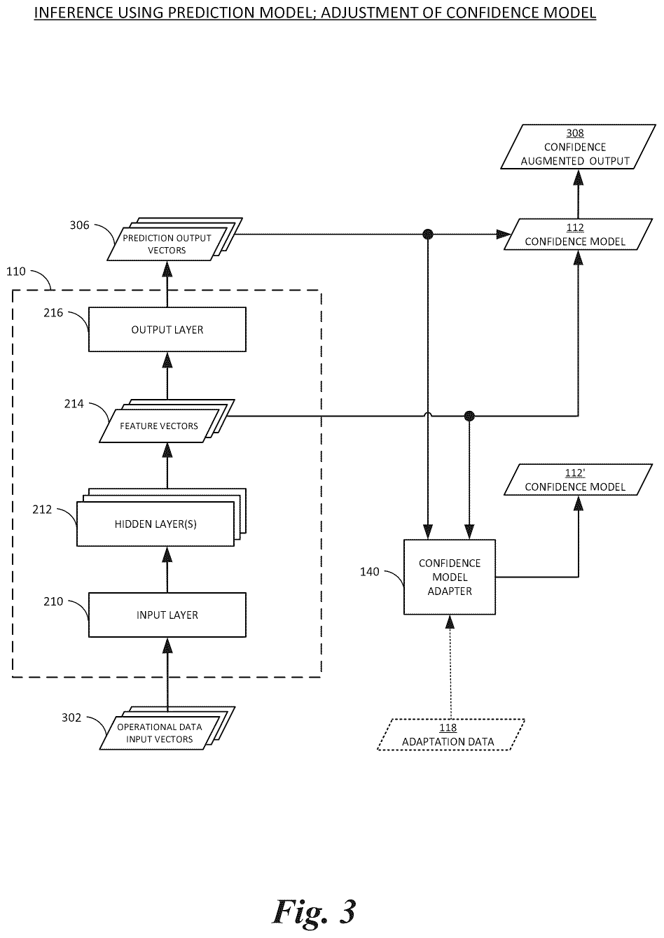

FIG. 3 illustrates use of a prediction model 110 and a confidence model 112 at inference time to evaluate operational data and adapt the confidence model 112 according to some embodiments. The confidence model 112 shown in FIG. 3 is a NN, such as the NN-based confidence model illustrated in FIG. 2 and trained in the example described above.

In some embodiments, instead of training data input vectors 202, at inference time the operational data that is evaluated by the prediction model 110 may be in the form of operational data input vectors 302. The prediction output data generated by the prediction model 110 may be in the form of prediction output vectors 306.

During generation of prediction output data, the prediction model 110 may generate or otherwise obtain feature space data comprising a representation of the operational data in the feature space of the prediction model 110. For example, the prediction model 110 may generate a feature vector 214. The feature vector 214 may be used by the confidence model 112 to determine a degree of confidence in the prediction output vector 306. In some embodiments, the inference service 104 may generate a confidence augmented output 308, such as a weighted prediction output, a combination of prediction output and confidence output, or the like.

The prediction output vector 306, feature vector 214, operational data input vector 302, other adaptation data 118, or some combination thereof may be used by the confidence model adapter 140 to adapt the confidence model 112 and generate modified confidence model 112′.

### Example Confidence Model Adaptation Routine

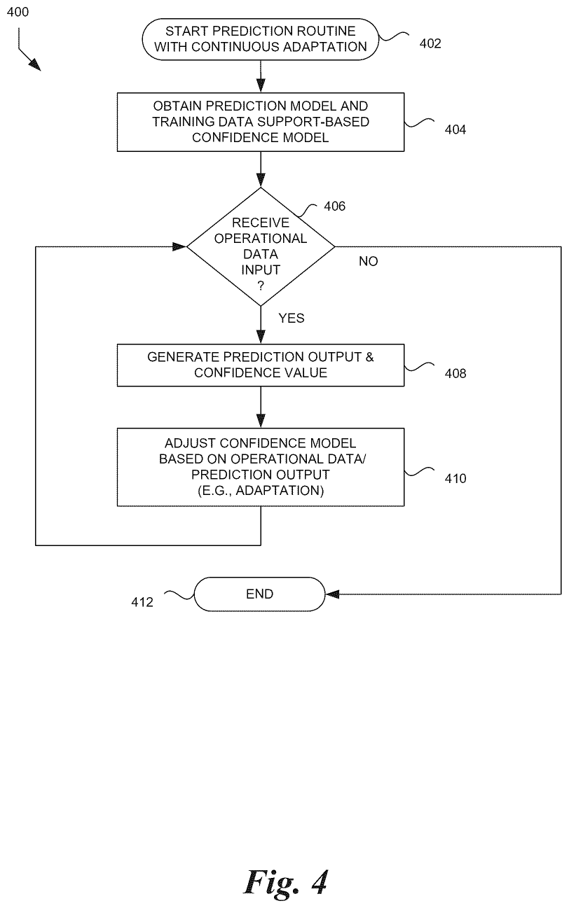

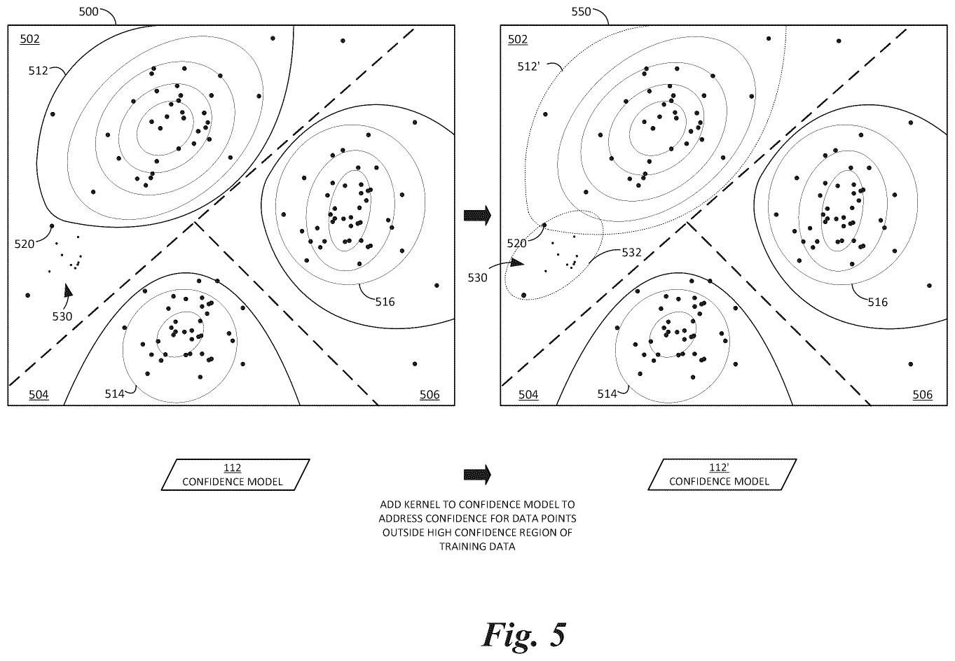

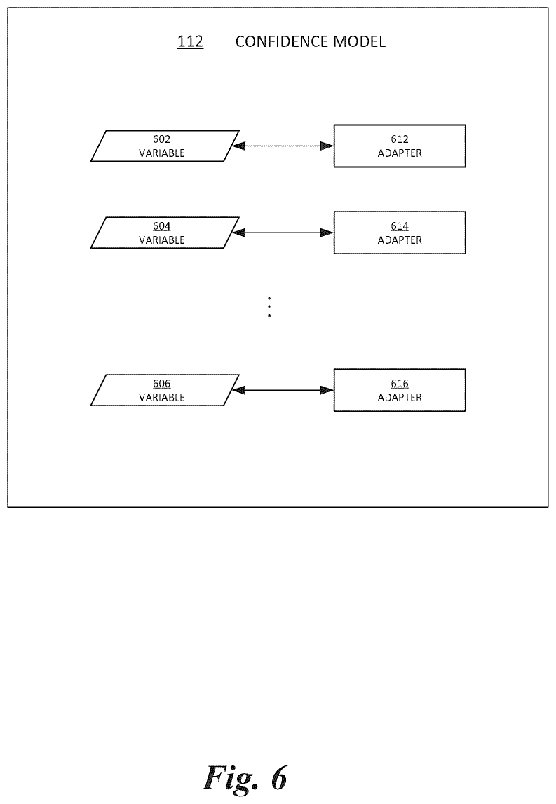

FIG. 4 illustrates an example routine 400 for generating confidence-augmented prediction output using a prediction model and a confidence model, and modifying the confidence model. Advantageously, an inference service 104 may execute the routine 400 or portions thereof to adapt the confidence model without requiring retraining or any downtime of the confidence model or use thereof. In some embodiments, another system, such as the management system 108, may perform the routine 400 or portions thereof to modify a confidence model. Routine 400 will be described with further reference to the example feature space points illustrated in FIG. 5 and the example confidence model 112 shown in FIG. 6.

Routine 400 begins at block 402. In some embodiments, routine 400 may begin in response to an event, such as an inference service 104 beginning operation. When the routine 400 begins, executable instructions may be loaded to or otherwise accessed in computer readable memory and executed by one or more computer processors, such as the memory and processors of computing system 900 described in greater detail below.

At block 404, the inference service 104 may obtain a prediction model 110 and a confidence model 112 from the model training service 102. In some embodiments, the prediction model 110 may be a NN-based machine learning model. The confidence model 112 may be or include one or more mixture density functions, distributions, or related metrics of training data support in the feature space for prediction output generated by the prediction model 110.

At decision block 406, the inference service 104 may determine whether operational data input has been received for prediction. If so, the routine 400 may proceed to block 408. Otherwise, if no operational data input has been received, the routine 400 may terminate at block 412.

At block 408, the inference service 104 may generate prediction output and a confidence value from the operational data input using the prediction model 110 and confidence model 112. In some embodiments, the inference service 104 may generate a classification or regression output from the operational data using the prediction model 110. The inference service 104 may also generate confidence output representing a degree of confidence in the prediction output based on the training data support in the feature space for the prediction output.

FIG. 5 illustrates, on the left side of the figure, a set 500 of feature space points generated from operational data during prediction operations. The feature space points are clustered in three different classes into which the prediction model 110 is configured to classify operational data inputs. Generally, the prediction model 110 may classify a given operational data input into a class if a feature space point is located within the boundaries of the class. In the illustration, the class boundaries are indicated in dashed lines. Three classes are shown: class 502, class 504, and class 506.

As discussed above, the classification determinations may not necessarily be supported by the training data used to train the prediction model 110. The confidence model 112 may be used to evaluate the training data support for the classification determinations. In the illustration, the generally elliptical lines correspond to different degrees of confidence. The concentric nature of the generally elliptical lines may be interpreted as topographical indicators in a third dimension overlayed on top of a two-dimensional set 500 of feature space points. Generally, higher degrees of confidence are represented by smaller ellipses with fewer internal ellipses, and thus higher values in the third dimension. Lower degrees of confidence are represented by larger ellipses with more internal ellipses, and thus lower values in the third dimension. The region within generally elliptical line 512 indicates a relatively low degree of confidence for class 502 such that feature space points outside of the region, including feature space point 520, may not be considered to be in class 502. The region within generally elliptical line 514 is a relatively low degree of confidence for class 504, and the region within generally elliptical line 516 is a relatively low degree of confidence for highest degree of confidence for class 506.

The example in FIG. 5 of a two-dimensional feature space with confidence indicated in a third dimension is for illustrative purposes only, and is not intended to be limiting or required. A topographical map with a height corresponding to degree of confidence in points and regions of a two-dimensional feature space is merely one method of visualizing confidence in feature space points and regions. Moreover, it will be appreciated that in some embodiments a feature space may be defined in three or more dimensions, and potentially a large number of dimensions (e.g., dozens, hundreds, or more).

Returning to FIG. 4, at block 410 the inference service 104 may adjust the confidence model 112 based on the operational data, prediction output, confidence output, other adaptation data, or some combination thereof.

FIG. 6 illustrates an example confidence model 112. The confidence model 112 includes a plurality of parameters, shown as variables: variable 602, variable 604, . . . , variable 606. To facilitate adjustment of the confidence model 112, individual variables may be adjusted using an adapter (e.g., an adaptive filter with a transfer function and an optimization algorithm to adjust one or more parameters). As shown, adapter 612 may be attached to variable 602; adapter 614 may be attached to variable 604, adapter 616 may be attached to variable 606, and so on. In some embodiments, the adaptors or subsets thereof may be Kalman filters, least mean squares (LMS) filters, recursive least squares (RLS) filters, Volterra LMS filters, kernel adaptive filters, spline adaptive filters, neural networks, or etc.

In response to an operational data input being received and processed by the prediction model 110 and confidence model 112, the adapters may adjust the variables to which they are assigned. In this way, the confidence model 112 may be adapted based on processing of operational data. The resulting adjusted confidence model 112′ may therefore be considered to be both training-support-based and operational-support-based. Over the course of time, a continuously adjusted confidence model 112′ may be more operational-support-based than training-support-based.

The example parameters and adapters shown in FIG. 6 and described herein are illustrative only, and are not intended to be limiting, required, or exhaustive. In some embodiments, fewer, additional, and/or alternative parameters and/or adapters may be used.

As discussed above, FIG. 5 illustrates feature space point 520 being outside a low degree of confidence represented by generally elliptical line 512. Thus, prior to adaptation of the confidence model 112, feature space point 520 was considered to be a low-confidence member of class 502 (or not a member of class 502). On the right side of FIG. 5, a set 550 of feature space points and corresponding degrees of confidence after adjustment is shown. In the illustrated example, after adaptation of the confidence model 112 into confidence model 112′, the confidence determination for class 502 may be altered such that feature space point 520 is now given a higher degree of confidence for being a member of class 502. The higher degree of confidence is illustrated in the figure by the modified generally elliptical line 512′, which now encompasses feature space point 520 in set 550 of feature space points. Over time, as more operational data inputs are evaluated and the confidence model 112′ is further adapted, the confidence determinations may be further modified. For example, a visual representation of such further modifications may include generally elliptical line 512′ being further expanded, concentric ellipses within generally elliptical line 512′ being expanded to encompass feature space point 520 and afford it an even higher degree of confidence, various ellipses or generally elliptical lines being contracted to afford feature space points lower degrees of confidence, etc.

With reference to an illustrative example, the prediction model 110 may be configured to classify data regarding clothing such as lower outer garments into one or more classes: class 502 may correspond to pants, class 504 may correspond to shorts, and class 506 may correspond to skirts. Data point 520 may be derived from an image of—or may otherwise represent—an item of clothing that should be considered pants but also exhibits characteristics of shorts (e.g., the legs are shorter than typical pants, but perhaps not as short as typical shorts) and therefore is somewhat farther away from the highest confidence regions of the feature space for pants. Adaptation of the confidence model 112 can help a system that uses the prediction model 110 and confidence model 112 to properly identify new inputs in this manner without requiring retraining of the underlying prediction model 110 (e.g., using data from which data point 520 is derived, such as an image of relatively short pants). Thus, over the course of time as shifts are observed in the features of members of a given class, the degree to which classification determinations are made with confidence can shift to adapt to the changing input.

In some embodiments, a kernel may be generated instead of, or in addition to, dynamic adaptation of the confidence model 112. The kernel may be used to improve the confidence of prediction model output for feature space points that fall outside of high confidence regions of the feature space modeled by the confidence model 112. As with confidence model adaption described elsewhere herein, using kernels in this manner can allow for adjustment in confidence determinations and confidence-augmented prediction output without retraining of the prediction model 110 or confidence model 112. Moreover, using kernels can advantageously provide such benefits without necessarily requiring expansion of the high confidence regions of the feature space modeled by the confidence model 112. Instead, individual areas of the feature space may benefit from adjusted confidence based on operational data.

A decision to generate a kernel for confidence evaluation purposes may be based on detecting a clustering of points in a feature space modeled by the confidence model 112, where the cluster is outside of the areas having a high degree of confidence. Once a cluster is detected, one or more criteria may be evaluated to determine whether to generate a kernel for the cluster. For example, a kernel generation criterion may relate to the quantity of feature space points in the cluster, the proportion of operational data inputs that result in feature space points in the cluster, the dispersion of the cluster (e.g., as defined in terms of standard deviation), some other criterion, or some combination thereof. If one or more kernel generation criteria are met, then a kernel may be generated.

With reference to an illustrative embodiment, a Gaussian kernel may be implemented to determine the distance of data points from the center of a particular cluster, such as cluster of feature space data points 530 associated with class 502 that are also located outside of generally elliptical line 512. The center of the particular cluster of feature space data points 530 may be indicated by the mean of the Gaussian that models the cluster. The difference between a point 520 and the mean may be divided by the standard deviation of the Gaussian that models the cluster. Depending upon which direction the point is offset from the mean in the feature space, the distance may be adjusted based on the standard deviation of the Gaussian in that direction. In this way, a feature space point 520 with a distance value (or adjusted distance value) that is within a particular threshold value for the kernel or otherwise within a particular feature space region (e.g., represented by ellipse 532) may be considered to be properly classified in a particular class (e.g., class 502) with a high degree of confidence even though the feature space point would otherwise be outside of a confidence threshold for the confidence model 112

In some embodiments, a kernel may be generated for prediction instead of, or in addition to, determinations of confidence by the confidence model 112. The kernel may be used to identify new classes based on observed clustering of feature space points in the feature space by the prediction model 110 from operational data. Using kernels in this manner can allow a system to classify operational data into new classes without retraining of the prediction model 110 or confidence model 112.

With reference to an illustrative embodiment, a kernel may be implemented to determine the distance of a particular data point (e.g., data point 520) from the center of a particular cluster of feature space data points 530. In contrast to the cluster of feature space points associated with the confidence-based kernel described above, the cluster of feature space points in this case may be within the area of the feature space associated with a class (e.g., class 502) but may be properly classified as an entirely separate class (e.g., dresses, rather than the existing classes of pants, shorts, and skirts). In this way, a feature space point 520 with a distance value (or adjusted distance value) that is within a particular threshold value or otherwise within a particular feature space region (e.g., represented by ellipse 532) for the kernel may be considered to be properly classified in a particular class (e.g., a new “dress” class) even though little or no data representing the particular class was evaluated during training of the prediction model 110.

### Example Asynchronous Confidence Model Adjustment Routine

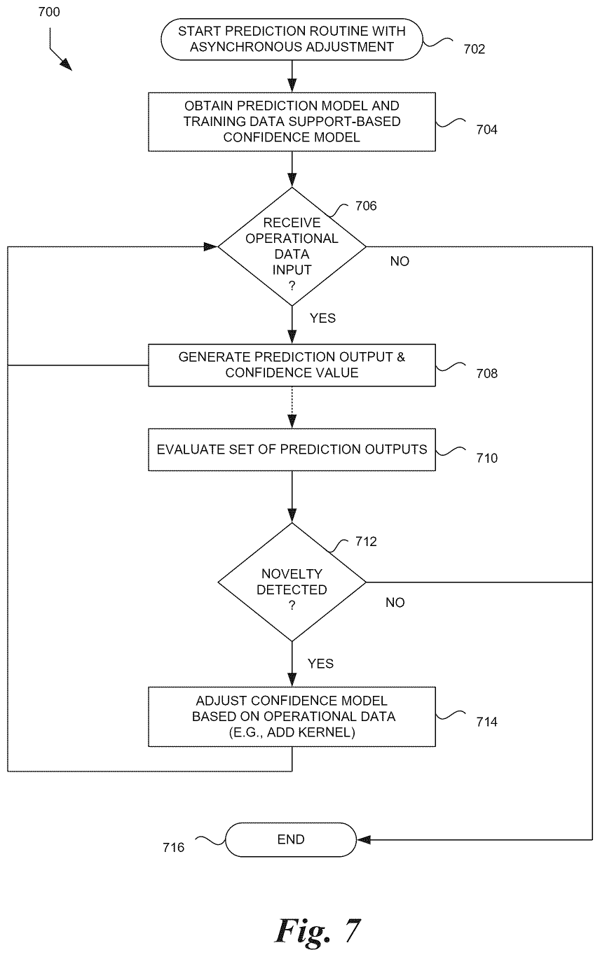

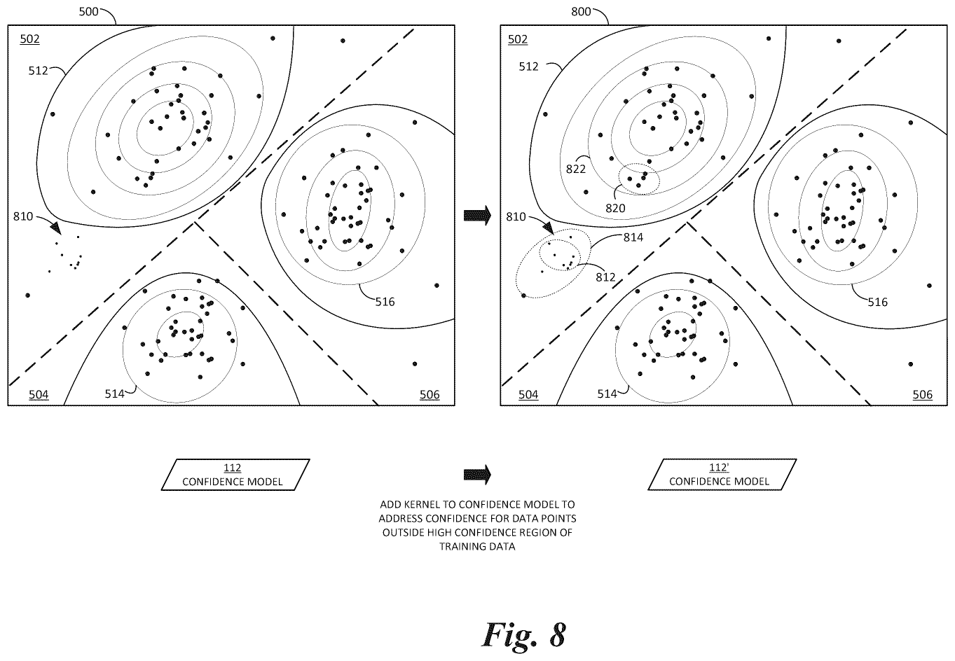

FIG. 7 illustrates another example routine 700 for generating confidence-augmented prediction output using a prediction model and a confidence model. In this example routine 700, an asynchronous process is used for evaluating results and related data, and for modifying the confidence model. Advantageously, a management system 108 may execute portions of the routine 700 to adjust the confidence model without requiring retraining of the prediction model 110 or the confidence model 112. In some embodiments, another system, such as the inference service 104, may perform some or all of the routine 700. Routine 700 will be described with further reference to the example feature space points illustrated in FIG. 8.

Routine 700 begins at block 702. In some embodiments, routine 700 may begin in response to an event, such as an inference service 104 and/or management system 108 beginning operation. When the routine 700 begins, executable instructions may be loaded to or otherwise accessed in computer readable memory and executed by one or more computer processors, such as the memory and processors of computing system 900 described in greater detail below.

At block 704, the inference service 104 may obtain a prediction model 110 and a confidence model 112 from the model training service 102. In some embodiments, the prediction model 110 may be a NN-based machine learning model. The confidence model 112 may be or include one or more mixture density functions, distributions, or related metrics of training data support in the feature space for prediction output generated by the confidence model 112.

At decision block 706, the inference service 104 may determine whether operational data input has been received for prediction. If so, the routine 700 may proceed to block 708. Otherwise, if no operational data input has been received, the routine 700 may terminate at block 716.

At block 708, the inference service 104 may generate prediction output and a confidence value from the operational data input using the prediction model 110 and confidence model 112. In some embodiments, the inference service 104 may generate a classification or regression output from the operational data using the prediction model 110. The inference service 104 may also generate confidence output representing a degree of confidence in the prediction output based on the training data support in the feature space for the prediction output.

FIG. 8 illustrates, on the left side of the figure, a set 500 of feature space points generated from operational data during prediction operations. As also shown and described with respect to FIG. 5, the feature space points are clustered in three different classes into which the prediction model 110 is configured to classify operational data inputs: class 502, class 504, and class 506. As discussed above, the confidence model 112 may be used to evaluate the training data support for the classification determinations. In the illustration, the generally elliptical lines correspond to different degrees of confidence.

Returning to FIG. 7, after block 708 the routine 700 may return to decision block 706 to determine whether additional operational data input is received. In some embodiments, the routine 700 may also or alternatively proceed to block 710, where the management system 108 may evaluate a set of prediction outputs. Evaluation of prediction output may include detecting novelties in the feature space points observed during prediction performed from operational data. Illustratively, the evaluation may be based on: usage data 116 regarding operational data inputs, prediction outputs, and/or confidence outputs; an analysis of training data 114; other adaptation data 118; or some combination thereof.

As shown in FIG. 8, feature space points 810 are outside the outer most generally elliptical line 512 for class 502. In this example, there may be a relatively low degree of confidence in a classification determination for feature space points 810. Nevertheless, the feature space points 810 may be detected as a cluster of feature space points with similar features due to their proximity to each other within the feature space. Such a cluster may be indicative of a novelty within the operational data. For example, the novelty may arise from a lack of similarly-featured training data used to train the prediction model 110, either due to a failure to obtain a sufficiently representative corpus of training data, or due to changing operational data and therefore the unavailability at training time of data associated with the features in this region of the feature space.

At decision block 712, once a cluster is detected, the management system 108 may evaluate one or more criteria to determine whether the cluster is to be considered a novelty and therefore trigger adjustment of the confidence model 112. For example, a novelty detection criterion may relate to the quantity of feature space points in the cluster, the proportion of operational data inputs that result in feature space points in the cluster, the dispersion of the cluster (e.g., as defined in terms of standard deviation), some other criterion, or some combination thereof. If one or more novelty criteria are met, then a novelty may be detected and the routine 700 may proceed to block 714.

At block 714, the management system 108 may adjust the confidence model 112 based on the operational data associated with the novelty. In some embodiments, a kernel may be added to treat the novelty separately from the rest of the feature space. Such a kernel may be generated as described above to provide one or more regions of relatively high degree(s) of confidence, where the regions would otherwise be outside of the high confidence regions of the feature space as modeled by the confidence model 112. For example, a Gaussian kernel may be implemented to define the cluster of feature space points 810. The degree of confidence in a given prediction may depend directly or at least partly on the distance of a particular feature space point, derived from operational data input, from the center of a particular cluster. For example, set 800 of feature space points includes a feature space point within generally elliptical line 812 that may have a first relatively high degree of confidence, while a feature space point outside of generally elliptical line 812 but within generally elliptical line 814 may have a second relatively lower degree of confidence than the first feature space point.

In some embodiments, a kernel may be used to define a low-confidence region of the feature space in an otherwise higher-confidence region. FIG. 8 illustrates a kernel of this type to define a lower-confidence region 820 within a region of relatively high confidence indicated by generally elliptical line 822. Advantageously, a kernel of this type may be used to mitigate or correct for an anomaly, such as a bias that may have been present in the training data or that the prediction model 110 has been observed to apply to operational data. For example, a prediction model 110 may be trained to evaluate prospective employee applications, resumes, etc. The prediction model 110 may be trained using training data derived from historical candidate selections. Any bias previously present in hiring may therefore be reflected in the training data, resulting in the prediction model 110 being trained apply the bias to operational data. A conventional approach to addressing this issue may involve curation of—and additional processing of—training data, and re-training of the prediction model 110. Although this approach could successfully resolve the identified issue, it may have unintended consequences on prediction model 110 performance due to the alterations to the training set. Moreover, the requirement to re-train the prediction model may be resource intensive or otherwise onerous. By generating a kernel for a cluster of feature space data points that exhibit such bias and are classified based on the bias (e.g., classified as poor employment candidates), the confidence in such predictions can be reduced and the effect of the bias can be mitigated.

Alternatively, or in addition, a kernel may be generated for classifying operational data in a new class, or for providing regression output that varies from what would otherwise be produced by the prediction model 110. Illustratively, such a kernel may be used to identify new classes based on observed clustering of feature space points in the feature space by the prediction model 110 from operational data. Using kernels in this manner can allow a system to classify operational data into new classes without retraining of the prediction model 110 or confidence model 112. For example, generally elliptical lines 812 and 814 may represent a Gaussian kernel that, in contrast to the cluster of feature space points associated with the confidence-based kernel described above, may be within the area of the feature space associated with a class (e.g., class 502) but may be properly classified as an entirely separate class. In this way, a feature space point with a distance value (or adjusted distance value) that is within a particular threshold value for the kernel may be considered to be properly classified in a particular class (e.g., a new “dress” class) even though little or no data representing the particular class was evaluated during training of the prediction model 110.

### Execution Environment

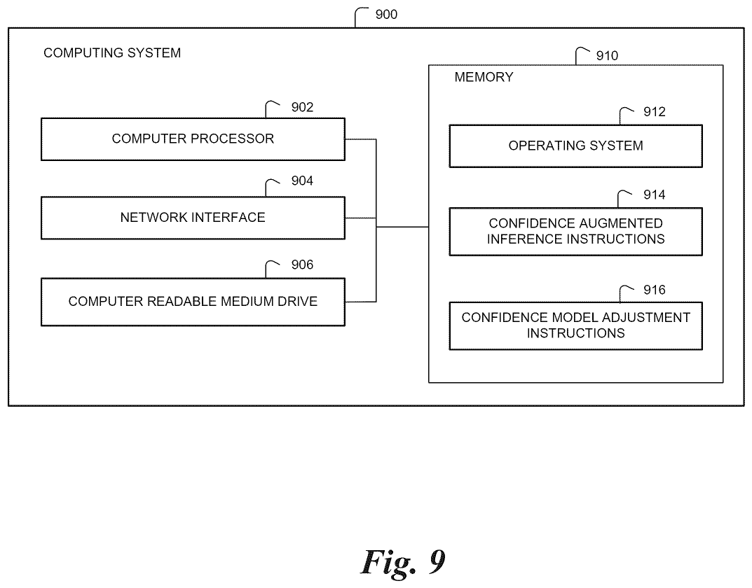

FIG. 9 illustrates various components of an example computing system 900 configured to implement various functionality described herein. The computing system 900 may be a physical host computing device on which an inference service 104 or some portion thereof is implemented.

In some embodiments, as shown, a computing system 900 may include: one or more computer processors 902, such as physical central processing units (“CPUs”); one or more network interfaces 904, such as a network interface cards (“NICs”); one or more computer readable medium drives 906, such as a high density disk (“HDDs”), solid state drives (“SSDs”), flash drives, and/or other persistent non-transitory computer readable media; and one or more computer readable memories 910, such as random access memory (“RAM”) and/or other volatile non-transitory computer readable media.

The computer readable memory 910 may include computer program instructions that one or more computer processors 902 execute and/or data that the one or more computer processors 902 use in order to implement one or more embodiments. For example, the computer readable memory 910 can store an operating system 912 to provide general administration of the computing system 900. As another example, the computer readable memory 910 can store confidence augmented inference instructions 914 for implementing confidence-augmented prediction. As another example, the computer readable memory 910 can store confidence model adjustment instructions 916 for adjusting a confidence model.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
computer-readable memory storing executable instructions; and
one or more processors programmed by the executable instructions to at least:
obtain a corpus of training data comprising a plurality of training data input vectors and a plurality of reference data output vectors, wherein a reference data output vector of the plurality of reference data output vectors represents a desired output generated by an artificial neural network from a corresponding training data input vector of the plurality of training data input vectors;
train the artificial neural network using the corpus of training data to generate classification determinations;
generate, using the artificial neural network and the corpus of training data, a generative confidence model of training data support for points in a feature space, wherein the artificial neural network is configured to generate a point in the feature space during generation of a classification determination; and
evaluate a plurality of operational input vectors using the artificial neural network and the generative confidence model, wherein to evaluate each operational input vector of the plurality of operational input vectors, the one or more processors are programed by the executable instructions to:
classify the operational input vector using the artificial neural network;
generate a confidence value for the classification determination using the generative confidence model; and
modify the generative confidence model based at least partly on application of adaptive filtering to one or more variables of the generative confidence model, wherein the generative confidence model, after modification, is configured to generate a different confidence value for the classification determination.

2. The system of claim 1, wherein to apply adaptive filtering to one or more variables of the generative confidence model, the one or more processors are further programmed by the executable instructions to apply a Kalman filter to a variable of the generative confidence model.

3. The system of claim 1, wherein the generative confidence model that is modified is configured to determine a second confidence value for a feature space point that corresponds to the operational input vector, wherein the second confidence value is higher than the confidence value, and wherein the feature space point is different from each of the points in the feature space observed during generation of the generative confidence model.

4. The system of claim 1, wherein the one or more processors are further programmed by the executable instructions to add a kernel to the generative confidence model based at least partly on results of evaluating the plurality of operational input vectors, wherein the kernel defines a region of the feature space associated with higher confidence than generated using the generative confidence model without the kernel.

5. A computer-implemented method comprising:
under control of a computing system comprising one or more processors configured to execute specific instructions,
obtaining a machine learning model trained to generate prediction outputs;
obtaining a confidence model of training data support for points in a feature space, wherein the machine learning model is configured to generate a point in the feature space during generation of a prediction output; and
evaluating a plurality of input data items using the machine learning model and the confidence model, wherein evaluating an input data item of the plurality of input data items comprises:
performing inference on the input data item using the machine learning model to generate prediction output data;
generating, using the confidence model, a confidence value for the prediction output data generated from the input data item; and
modifying the confidence model based at least partly on application of adaptive filtering to one or more variables of the confidence model.

6. The computer-implemented method of claim 5, wherein modifying the confidence model comprises configuring the confidence model to generate a different confidence value for a classification of the input data item into a class.

7. The computer-implemented method of claim 5, wherein obtaining the confidence model comprises generating one of: Gaussian mixture model to represent at least a subset of the points in a training data feature space, or a clustering model to represent at least a subset of the points in the training data feature space.

8. The computer-implemented method of claim 5, wherein obtaining the machine learning model comprises:
obtaining a corpus of training data comprising a plurality of training data input vectors and a plurality of reference data output vectors, wherein a reference data output vector of the plurality of reference data output vectors represents a desired output generated by an artificial neural network from a corresponding training data input vector of the plurality of training data input vectors; and
training the artificial neural network using the corpus of training data to generate classification determinations.

9. The computer-implemented method of claim 5, wherein modifying the confidence model comprises applying a Kalman filter to a variable of the confidence model.

10. The computer-implemented method of claim 9, wherein modifying the confidence model further comprises applying a second Kalman filter to a second variable of the confidence model.

11. The computer-implemented method of claim 5, further comprising adding a kernel to the confidence model based at least partly on results of evaluating the plurality of input data items, wherein the kernel defines a region of the feature space associated with a higher confidence value than generated using the confidence model without the kernel.

12. The computer-implemented method of claim 11, further comprising:
determining that the region of the feature space is associated with a second region of the feature space, wherein the region of the feature space is associated with a first degree of confidence that is lower than a second degree of confidence associated with the second region of the feature space; and
determining, based on the region of the feature space being associated with the second region of the feature space, to add the kernel defining the region of the feature space to the confidence model.

13. The computer-implemented method of claim 5, further comprising adding a kernel to the confidence model based at least partly on results of evaluating the plurality of input data items, wherein the kernel defines a region of the feature space associated with a lower confidence value than generated using the confidence model without the kernel.

14. The computer-implemented method of claim 13, further comprising:
determining that the region of the feature space is associated with a training data bias; and
determining, based on the region of the feature space being associated with the training data bias, to add the kernel defining the region of the feature space to the confidence model.

15. A system comprising:
computer-readable memory storing executable instructions; and
one or more processors programmed by the executable instructions to at least:
obtain a machine learning model trained to generate prediction outputs;
obtain a confidence model of training data support for points in a feature space, wherein the machine learning model is configured to generate a point in the feature space during generation of a prediction output; and
evaluate a plurality of input data items using the machine learning model and the confidence model, wherein to evaluate an input data item of the plurality of input data items, the one or more processors are programed to:
perform inference on the input data item using the machine learning model to generate prediction output data;
generate, using the confidence model, a confidence value for the prediction output data generated from the input data item; and
add a kernel to the confidence model based at least partly on results of evaluating the plurality of input data items, wherein the kernel defines a region of the feature space associated with a different confidence value than generated using the confidence model without the kernel.

16. The system of claim 15, wherein the one or more processors are further programmed by the executable instructions to:
determine that the region of the feature space is associated with a second region of the feature space, wherein the region of the feature space is associated with a first degree of confidence that is lower than a second degree of confidence associated with the second region of the feature space; and
determine, based on the region of the feature space being associated with the second region of the feature space, to add the kernel defining the region of the feature space to the confidence model.

17. The system of claim 15, wherein the one or more processors are further programmed by the executable instructions to:
determine that the region of the feature space is associated with a training data bias; and
determine, based on the region of the feature space being associated with the training data bias, to add the kernel defining the region of the feature space to the confidence model.

18. The system of claim 15, wherein the one or more processors are further programmed by the executable instructions to receive, from a management computing system, bias data indicating the region of the feature space is associated with a training data bias, wherein the kernel is added in response to receiving the bias data.

19. The system of claim 15, wherein to evaluate the plurality of input data items, the one or more processors are further programmed by the executable instructions to modify the confidence model based at least partly on application of adaptive filtering to one or more variables of the confidence model.

20. The system of claim 15, wherein the confidence model comprises one of: a Gaussian mixture model to represent at least a subset of the points in a training data feature space, or a clustering model to represent at least a subset of the points in the training data feature space.
